(19) United States
(12) Patent Application Publication
(10) Pub. No.: US 2022/0338062 A1
(43) Pub. Date: Oct. 20, 2022

(54) METHODS, APPARATUS AND SYSTEMS FOR PERFORMING LOAD DISTRIBUTION IN NETWORK

(71) Applicant: SAMSUNG ELECTRONICS CO., LTD., Suwon-si, Gyeonggi-do (KR)

(72) Inventors: Andrew BENNETT, Suwon-si (KR); David Gutierrez ESTEVEZ, Suwon-si (KR)

(21) Appl. No.: 17/760,743

(22) PCT Filed: Sep. 17, 2020
(86) PCT No.: PCT/KR2020/012535

§ 371 Date: Mar. 15, 2022

(30) Foreign Application Priority Data
Sep. 17, 2019 (GB) 1913417.0
May 22, 2020 (GB) 2007729.3

(51) Int. Cl. H04W 28/08; H04W 28/02; H04W 48/06; H04W 76/18; H04L 43/0876

(52) U.S. Cl. CPC H04W 28/0958; H04W 28/0268; H04W 48/06; H04W 76/18; H04L 43/0876; H04L 41/0816

(57) ABSTRACT

There is disclosed a method, performed by a first network entity, for load distribution in a network comprising the first entity and a second network entity providing network analytics. The method includes: receiving, from the second entity, slice analytics; and determining, based on the slice analytics, to perform a network operation.

### CROSS-REFERENCE TO RELATED APPLICATIONS

This application is a 371 of International Application No. PCT/KR2020/012535 filed Sep. 17, 2020, which claims priority to United Kingdom Patent Application No. 1913417.0 filed Sep. 17, 2019, and United Kingdom Patent Application No. 2007729.3 filed May 22, 2020, the disclosures of which are herein incorporated by reference in their entirety.

### BACKGROUND

### 1. Field

Certain examples of the disclosure provide methods, apparatus and systems for performing load distribution in a network. For example, certain examples of the disclosure provide methods, apparatus and systems for performing Network Slice (NS) and/or Network Slice Instance (N SI) load distribution based on a Network Data Analytics Function (NWDAF) in 3GPP 5G Core Network (5GC).

### 2. Description of Related Art

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (L 1E) system’. The 5G communication system is considered to be implemented in higher frequency (mmWave) bands, e.g., 60 GHz bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required.

### SUMMARY

In accordance with an aspect of the disclosure, a method, performed by a first network entity, for load distribution in a network comprising the first entity and a second network entity providing network analytics, includes receiving, from the second entity, slice analytics; and determining, based on the slice analytics, to perform a network operation.

### BRIEF DESCRIPTION OF THE DRAWINGS

FIG. 1 illustrated an example of the composition of an S-NSSAI;

FIG. 2 illustrates a first call flow: NSSF subscription to NSI load analytics according to an exemplary embodiment of the disclosure;

FIG. 3 illustrates a second call flow: Simplified registration procedure with NSI load analytics subscription according to an exemplary embodiment of the disclosure;

FIG. 4 illustrates a third call flow: PDU session establishment with NSI-ID allocation according to an exemplary embodiment of the disclosure;

FIG. 5 illustrates a fourth call flow: PDU session establishment without NSI-ID allocation according to an exemplary embodiment of the disclosure;

FIG. 6 illustrates a fifth call flow: first example for NSI load distribution according to an exemplary embodiment of the disclosure;

FIG. 7 illustrates a sixth call flow: second example for NSI load distribution according to an exemplary embodiment of the disclosure;

FIG. 8 illustrates a seventh call flow: third example for NSI load distribution according to an exemplary embodiment of the disclosure;

FIG. 9 illustrates examples in which a network operation (e.g. network load distribution) is performed based on slice analytics and involving NSSF according to an exemplary embodiment of the disclosure;

FIG. 10 illustrates examples of a network operation based on network slice restriction with and without quota management, according to an exemplary embodiment of the disclosure;

FIG. 11 illustrates an example of a network operation based on network slice instance restriction, according to an exemplary embodiment of the disclosure;

FIG. 12 illustrates examples in which a network operation (e.g. network load distribution) is performed based on slice analytics and involving AMF, according to an exemplary embodiment of the disclosure;

FIG. 13 illustrates examples of a network operation based on network slice restriction with and without quota management, according to an exemplary embodiment of the disclosure;

FIG. 14 illustrates an example of a network operation based on network slice instance restriction, according to an exemplary embodiment of the disclosure; and

FIG. 15 is a block diagram of a network entity according to an exemplary embodiment of the disclosure.

FIG. 16 illustrates a block diagram of a user equipment (UE), according to an exemplary embodiment of the disclosure.

### DETAILED DESCRIPTION

The following description with reference to accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While describing the embodiments, technical content that is well known in the related fields and not directly related to the disclosure will not be provided. By omitting redundant descriptions, the essence of the disclosure will not be obscured and may be clearly explained.

For the same reasons, components may be exaggerated, omitted, or schematically illustrated in drawings for clarity. Also, the size of each component does not completely reflect the actual size. In the drawings, like reference numerals denote like elements.

As used herein, the term “and/or” includes any and all combinations of one or more of the associated listed items. Expressions such as “at least one of,” when preceding a list of elements, modify the entire list of elements and do not modify the individual elements of the list. Throughout the disclosure, the expression “at least one of a, b or c” indicates only a, only b, only c, both a and b, both a and c, both b and c, all of a, b, and c, or variations thereof.

Advantages and features of one or more embodiments of the disclosure and methods of accomplishing the same may be understood more readily by reference to the following detailed description of the embodiments and the accompanying drawings. In this regard, the embodiments may have different forms and should not be construed as being limited to the descriptions set forth herein. Rather, these embodiments are provided so that this disclosure will be thorough and complete and will fully convey the concept of the embodiments to one of ordinary skill in the art, and the disclosure will only be defined by the appended claims.

Here, it will be understood that combinations of blocks in flowcharts or process flow diagrams may be performed by computer program instructions. Since these computer program instructions may be loaded into a processor of a general purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated consecutively may actually be executed substantially concurrently, or the blocks may sometimes be performed in a reverse order according to the corresponding function.

Here, the term “unit” in the embodiments of the disclosure means a software component or hardware component such as a field-programmable gate array (FPGA) or an application-specific integrated circuit (ASIC) and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with a smaller number of components and “units”, or may be divided into additional components and “units”. Furthermore, the components and “units” may be embodied to reproduce one or more central processing units (CPUs) in a device or security multimedia card. Also, in the embodiments, the “unit” may include at least one processor. In the disclosure, a controller may also be referred to as a processor.

A wireless communication system has evolved from providing initial voice-oriented services to, for example, a broadband wireless communication system providing a high-speed and high-quality packet data service, such as communication standards of high speed packet access (HSPA), long-term evolution (LTE) or evolved universal terrestrial radio access (E-UTRA), and LTE-Advanced (L IE-A) of 3rd Generation Partnership Project (3GPP), high rate packet data (HRPD) and ultra mobile broadband (UMB) of 3GPP2, and IEEE 802.16e. A 5th generation (5G) or new radio (NR) communication standards are being developed with 5G wireless communication systems.

Hereinafter, one or more embodiments will be described with reference to accompanying drawings. Also, in the description of the disclosure, certain detailed explanations of related functions or configurations are omitted when it is deemed that they may unnecessarily obscure the essence of the disclosure. All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies, and thus, the terms used herein have to be defined based on the meaning of the terms together with the description throughout the specification. Hereinafter, a base station may be a subject performing resource assignment of a terminal, and may be at least one of a gNode B, an eNode B, a Node B, a base station (BS), a wireless access unit, a base station controller, and a node on a network. A terminal may include user equipment (UE), a mobile station (IVIS), a cellular phone, a smart phone, a computer, or a multimedia system capable of performing communication functions, or the like. In the disclosure, a DL is a wireless transmission path of a signal transmitted from a base station to a terminal, and a UL is a wireless transmission path of a signal transmitted from a terminal to a base station. Throughout the specification, a layer (or a layer apparatus) may also be referred to as an entity. Also, hereinbelow, one or more embodiments of the disclosure will be described as an example of an LTE or LTE-A system, but the one or more embodiments may also be applied to other communication systems having a similar technical background or channel form. For example, 5G mobile communication technology (5G, new radio, NR) developed after LTE-A may be included. In addition, the one or more embodiments may be applied to other communication systems through some modifications within the scope of the disclosure without departing from the scope of the disclosure according to a person skilled in the art.

In an LTE system as a representative example of the broadband wireless communication system, an orthogonal frequency division multiplexing (OFDM) scheme is used in a DL and a single carrier frequency division multiplexing (SC-FDMA) scheme is used in a UL. The UL refers to a wireless link through which a terminal, UE, or a MS transmits data or control signals to a BS or a gNode B, and the DL refers to a wireless link through which a BS transmits data or control signals to a terminal. In such a multiple access scheme, data or control information of each user is classified by generally assigning and operating the data or control information such that time-frequency resources for transmitting data or control information for each user do not overlap each other, that is, such that orthogonality is established.

Terms such as a physical channel and a signal in an existing LTE or LTE-A system may be used to describe methods and apparatuses suggested in the disclosure. However, the content of the disclosure is applied to a wireless communication system, instead of the LTE or LTE-A system.

*37In 3GPP 5G System (5GS), the following are defined (e.g. in 3GPP TS 23.501). A Network Slice (NS) is defined as a logical network that provides specific network capabilities and network characteristics. A Network Slice Instance (NSI) is defined as a set of Network Function instances and the required resources (e.g. compute, storage and networking resources) which form a deployed NS. A Network Function (NF) is defined as a 3GPP adopted or 3GPP defined processing function in a network, which has defined functional behaviour and 3GPP defined interfaces. NFs in 3GPP 5G Core Network (5GC) include a Network Data Analytics Function (NWDAF) (as defined in 3GPP TS 23.288) and a Network Slice Selection Function (NSSF).

The NSSF supports functionality including selecting the set of NSIs serving a UE. The NWDAF provides load level information to an NF on a network slice instance level. The NWDAF notifies slice specific network status analytics information to the NFs that are subscribed to it. An NF may collect directly slice specific network status analytics information from NWDAF. NSSF may be a consumer of network analytics provided by NWDAF. NSSF may use the load level information provided by NWDAF for slice selection.

A key issue in the SA2 enablers for Network Automation (eNA) work items (in both Rel-16 and Rel-17), is how to guarantee slice service level agreements (SLAs). Hence, it is currently under study how NWDAF and its different analytics could assist in the task of guaranteeing a slice's SLA previously agreed between tenant and operator. One possible control plane based method to assist with such task is NSI load distribution.

However, specification of the management of NS/NSI load is incomplete in Rel-16 if Single Network Slice Selection Assistance Information (S-NSSAI) (“slice”) is implemented in a network by more than one NSI.

Certain examples of the disclosure provide methods, apparatus and systems for performing load distribution in a network. For example, certain examples of the disclosure provide methods, apparatus and systems for performing NS and/or NSI load distribution based on a NWDAF in 3GPP 5GC. However, the skilled person will appreciate that the invention is not limited to these examples, and may be applied in any suitable system or standard, for example one or more existing and/or future generation wireless communication systems or standards.

The following examples are applicable to, and use terminology associated with, 3GPP 5GS. However, the skilled person will appreciate that the techniques disclosed herein are not limited to 3GPP 5GS. For example, the functionality of the various network entities disclosed herein may be applied to corresponding or equivalent entities in other communication systems or standards. Corresponding or equivalent entities may be regarded as entities that perform the same or similar role within the network. For example, the functionality of the NWDAF in the examples below may be applied to any other suitable type of entity providing network analytics; the functionality of the NSSF in the examples below may be applied to any other suitable type of entity performing a network slice selection function; and the functionality of the Access and Mobility Management Function (AMF) in the examples below may be applied to any other suitable type of entity performing mobility management functions. The skilled person will also appreciate that the transmission of information between network entities is not limited to the specific form or type of messages described in relation to the examples disclosed herein.

In the following, a Network Slice (NS) may be defined as a logical network that provides specific network capabilities and network characteristics; a Network Slice Instance (NSI) may be defined as a set of Network Function instances and the required resources (e.g. compute, storage and networking resources) which form a deployed Network Slice; an NSI ID may be defined as an identifier for identifying the Core Network part of a Network Slice instance when multiple Network Slice instances of the same Network Slice are deployed, and there is a need to differentiate between them in the 5GC.

Network slices may differ for supported features and network functions optimisations, in which case such Network Slices may have e.g. different Single Network Slice Selection Assistance Information's (S-NSSAIs) with different Slice/Service Types. The operator can deploy multiple Network Slices delivering exactly the same features but for different groups of UEs, e.g. as they deliver a different committed service and/or because they are dedicated to a customer, in which case such Network Slices may have e.g. different S-NSSAIs with the same Slice/Service Type but different Slice Differentiators.

The network may serve a single UE with one or more Network Slice instances simultaneously via a 5G-Access Network(AN) regardless of the access type(s) over which the UE is registered (i.e. 3GPP Access and/or non-3GPP(N3GPP) Access). The AMF instance serving the UE logically belongs to each of the Network Slice instances serving the UE, i.e. this AMF instance is common to the Network Slice instances serving a UE.

The selection of the set of Network Slice instances for a UE is triggered by the first contacted AMF in a Registration procedure normally by interacting with the NSSF, and can lead to a change of AMF.

In the following, a Protocol Data Unit (PDU) Connectivity Service may be defined as a service that provides exchange of PDUs between a UE and a Data Network; a PDU Session may be defined as an association between the UE and a Data Network that provides a PDU connectivity service.

A PDU Session belongs to one and only one specific Network Slice instance per Public Land Mobile Network (PLMN). Different Network Slice instances do not share a PDU Session, though different Network Slice instances may have slice-specific PDU Sessions using the same Data Network Name (DNN).

The set of Network Slices for a UE can be changed at any time while the UE is registered with a network, and may be initiated by the network, or by the UE, under certain conditions as described below.

The network, based on local policies, subscription changes and/or UE mobility, operational reasons (e.g. a Network Slice instance is no longer available or load level information for a network slice instance provided by the NWDAF), may change the set of Network Slice(s) to which the UE is registered and provide the UE with a new Registration Area and/or Allowed NSSAI and the mapping of this Allowed NSSAI to Home Public Land Mobile Network (HPLMN) S-NSSAIs, for each Access Type over which the UE is registered.

In the following examples, a network may include a User Equipment (UE), an Access and Mobility Management Function (AMF) entity, a Network Slice Selection Function (NSSF) entity; and a Network Data Analytics Function (NWDAF) entity.

A particular network function can be implemented either as a network element on a dedicated hardware, as a software instance running on a dedicated hardware, or as a virtualised function instantiated on an appropriate platform, e.g. on a cloud infrastructure. A NF service may be defined as a functionality exposed by a NF through a service based interface and consumed by other authorized NFs.

NWDAF:

NWDAF represents operator managed network analytics logical function providing slice specific network data analytics to a NF. Stage 2 architecture enhancements for 5GS to support network data analytics services in 5GC are defined in 3GPP TS 23.288 (e.g. V 16.0.0). The NWDAF is part of the architecture specified in 3GPP TS 23.501 (e.g. V 15.6.0).

The NWDAF services are used to expose load level analytics from the NWDAF to the consumer NF (e.g. NSSF). Analytics may be filtered by (i) Network Slice Instance, (ii) Load Level Threshold value: the NWDAF reports when the load level crosses the threshold provided in the analytics subscription; if no threshold is provided in the subscription, the reporting (Notify operation) is assumed to be periodic.

The NWDAF provides load level information to an NF on a network slice instance level. The NWDAF is not required to be aware of the current subscribers using the slice. The NWDAF notifies slice specific network status analytics information to the NFs that are subscribed to it. An NF may collect directly slice specific network status analytics information from NWDAF. This information is not subscriber specific.

AMF:

The 5GC AMF receives all connection and session related information from the UE (N1/N2) but is responsible only for handling connection and mobility management tasks. All messages related to session management are forwarded over the N11 reference interface to the Session Management Function (SMF). The AMF performs the role of access point to the 5GC. The functional description of AMF is given in 3GPP TS 23.501 clause 6.2.1.

NSSF:

The functional description of NSSF is given in 3GPP TS 23.501 clause 6.2.14. NSSF supports the following functionality: (i) Selecting the set of Network Slice instances serving the UE, (ii) Determining the Allowed NSSAI and, if needed, the mapping to the Subscribed S-NSSAIs, (iii) Determining the Configured NSSAI and, if needed, the mapping to the Subscribed S-NSSAIs, (iv) Determining the AMF Set to be used to serve the UE, or, based on configuration, a list of candidate AMF(s), possibly by querying the Network Repository Function (NRF).

Load Distribution:

A key issue in the Service and System Aspects Working Group 2 (SA2) enablers for Network Automation (eNA) work items (in both Rel-16 and Rel-17), is how to guarantee slice service level agreements (SLAs). Hence, it is currently under study how NWDAF and its different analytics could assist in the task of guaranteeing a slice's SLA previously agreed between tenant and operator. One possible control plane based method to assist with such task is Network Slice Instance (NSI) load distribution, as explained below.

Examples of the disclosure proposes NSI load distribution for SLA guarantee utilizing data analytics in the 5GC control plane. The term load distribution is employed here as an augmented version of the conventional term of load balancing, where load balancing usually refers to the management of load with the purpose of achieving an even distribution. Load distribution is a wider term referring to the ability of the network to distribute load in any possible way, not just in an even fashion. Hence, load balancing is just one form of load distribution. There are several reasons why it would be beneficial to distribute load unevenly across NSIs, as it will be explained further below.

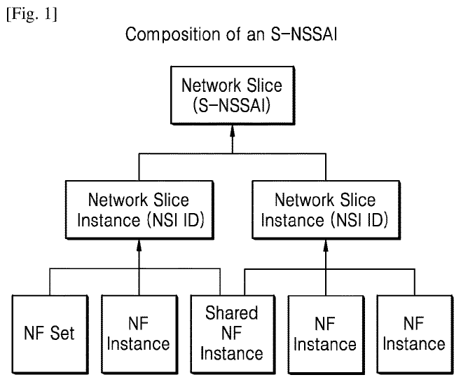

FIG. 1 illustrated an example of the composition of an S-NSSAI. Referring to FIG. 1, load distribution (and load balancing) can be thought of as being applicable to three levels of hierarchy: Network Slice, Network Slice Instance, and Network Function. For the purposes of this discussion the 3GPP concepts of NF Set and NF Service set can be ignored, as an NF Set can be seen as an NF instance, and an NF Service Set is part of an NF instance. An NF Set contains multiple NF instances of the same type that share (or can transfer) context data, and are interchangeable, so can be treated as equivalent to an NF instance. The Service Communications Proxy (SCP) can also be ignored in the context of this discussion.

For the traffic related to a Network Slice (identified by an S-NSSAI) the load can be distributed between the NSIs that comprise the Slice (assuming the NSIs are capable of serving the traffic coming from the UEs, e.g. they serve the same areas). Currently (pre Rel-17) the NWDAF can report NSI load level information (i.e., load level threshold crossings) to a consumer such as the NSSF, and this could be used to determine which NSI to use for a particular PDU Session. However, the specifications do not define how NSI load is determined, and they are not explicit on whether the NSSF is allowed to perform load distribution across NSIs, and how load distribution would be performed.

Within each NSI the load can be distributed between the NF instances that comprise the NSI. For example, SMF discovery and selection involving the AMF and the NRF in an NSI can take into account the load levels of the SMFs that are part of the NSI.

NWDAF Slice Level Analytics:

In Rel-16, SA2 has specified two types of analytics at slice level, namely (1) slice load and (2) slice Quality of Experience (QoE) analytics.

Slice Load

Slice load level data analytics as described in TS 23.288 refer to NSI level and are provided in two possible formats: (i) when a load threshold is provided as analytic filter by the consumer NF in the slice load subscription message, NWDAF informs the consumer NF of such threshold crossings each time they happen, and (ii) when no load threshold is provided by the consumer NF, NWDAF provides periodic notifications to the consumer NF reporting the NSI load.

There are a number of problems with the current status of the NSI load analytics specification:

It is not clear which metric should be used to represent NSI load values (e.g., percentages) and how to derive such values from the load levels of member NFs of the NSI. Even if the derivation itself is left as implementation specific, the specification should provide support for such functionality, where NSI load is assumed to be derivable from NF load values in a proprietary way.

Slice load refers to an NSI, but the use of an NSI-ID to refer to an NSI is not mandatory.

NWDAF is supposed to provide statistics and predictions for each analytics type. However, it is currently unclear whether in the case of NSI load statistics and predictions would be provided at all, and if so whether they would be provided for load values directly and/or for load threshold crossings.

Slice QoE

Slice QoE analytics as described in TS 23.288 refer to S-NSSAI level and they are derived using observed service experience analytics provided for UEs and applications on such S-NSSAI. These analytics have the potential to provide evidence of a correlation between slice load and slice SLA when it exists.

Network Slice/Network Slice Instance Load Specification:

Specification of the management of Network Slice/Network Slice Instance load is incomplete in Rel-16 if an S-NSSAI (“slice”) is implemented in a network by more than one Network Slice Instance. For single-NSI S-NSSAI, a congestion control mechanism is available as specified in clause 5.19.7.2 of TS 23.501.

However, there are a number of reasons for having more than one NSI per S-NSSAI.:

NSI per data centre, for resilience purposes.

NSI per geographic region, to manage delay times and also increase resilience.

NSI per vendor, to minimize inter-vendor interworking.

Multiple NSIs to contain the impact of serious network malfunction (reduce the chance of a malfunction in one part of the next spreading to others).

Multiple NSIs to control rollout of new software/equipment.

In addition, even if multiple NSIs logically exist, not all of them need to be operating. An additional NSI may be instantiated when it is needed by the network, and similarly, an NSI may be de-instantiated at some point if decided by the network due to e.g. power consumption reasons. The de-instantiation of an NSI is a clear case of NSI load distribution vs just load balancing, as the NSI to be de-instantiated will still require its remaining load to be re-distributed to another NSI before performing the de-instantiation.

Each UE identifies the slices that they want to use through the use of S-NSSAIs, but if there are multiple NSIs serving that S-NSSAI then the network needs to choose which NSI should serve the UE. As currently described in Rel-16 the choice of NSI can be made during two procedures: (1) UE registration, and (2) PDU session establishment by a UE.

UE Registration Request

An AMF handles this request and works in conjunction with the NSSF to decide what S-NSSAI's are allowed for the UE in this area

The NSSF optionally provides the AMF with a list of NSI-IDs identifying NSI's selected for the S-NSSAI's and NRFs that can be used to select NFs within these NSIs
If the NSSF does provide the NSI-IDs and NRFs then this means the NSSF has selected the NSIs, and could have taken into account: NSI load levels obtained from the NWDAF (though it isn't defined how the load levels are calculated by the NWDAF)

*91—At the end of the registration procedure the UE knows the allowed S-NSSAIs.

The AMF also knows the UE's allowed S-NSSAIs. It might also know some or all of the NSI-IDs of the NSIs selected to provide the functionality for some or all of the S-NSSAIs

For example, after a successful registration the UE could be allowed to use S-NSSAI A, but it is up to the operator to decide whether or not the AMF is told which NSI (and NRF) to use for that UE when it wants to establish PDU sessions. If the AMF is told then it uses that NSI for all PDU sessions for S-NSSAI A.

(2) UE PDU Session Establishment Request

Alternatively, an NSI can be allocated during a PDU session establishment request:

The UE decides, based on NSSPs, which S-NSSAI and DNN to use for a session includes this information in the request.

The AMF needs to know which NRF to query. This could be locally configured, could have been obtained from the NSSF during registration. Alternatively the AMF can query the NSSF to obtain the NRF (it sends the S-NSSAI and location, and NSI-ID, if it has it). The NSSF can take into account NSI load levels obtained from the NWDAF, as mentioned above.

The AMF is then able to select an SMF by interacting with the NRF that serves the NSI. Note that there could be an NRF per NSI, or there could be an NRF serving multiple NSIs.

The NRF gives the AMF a set of discovered SMF instances. It can also provide an NSI-ID, and if it does, this is used for subsequent NRF queries.
The NRF can use NF load information obtained from the NWDAF to determine which SMF to select.

Thus the NSI to be used for a UE for an S-NSSAI can be chosen at the time of UE registration, or can be decided when a PDU session is established. In the latter case a different NSI could in principle be used for each PDU session establishment, or a NSI could be chosen for future sessions (and this NSI could replace the one chosen at UE registration).

However, there are problems with these procedures when considering the need for different NSI's to be used for a UE for an S-NSSAI. Such a need can arise if the operator wants to steer some, or all, of the UEs away from an NSI, or towards others (e.g. an NSI is planned to be taken out of service, is overloaded, or is malfunctioning). If an NSI ID has been allocated to a UE (either at registration time, or for a previous PDU session request) then the AMF will continue to use that NSI ID for all subsequent PDU session requests. There is currently no procedure for telling the AMF to use a different NSI (except through a re-registration). On the other hand, if an NSI ID has not been allocated then each PDU session can be served by a different NSI (the AMF interacts with the NSSF to obtain an NRF that serves the NSI). This latter approach seems to avoid the problems associated with allocating/assigning an NSI ID, but has the drawback of requiring an interaction with the NSSF for every PDU Session Establishment.

Certain examples of the disclosure address the problem of how to perform NSI load balancing exploiting NWDAF analytics.

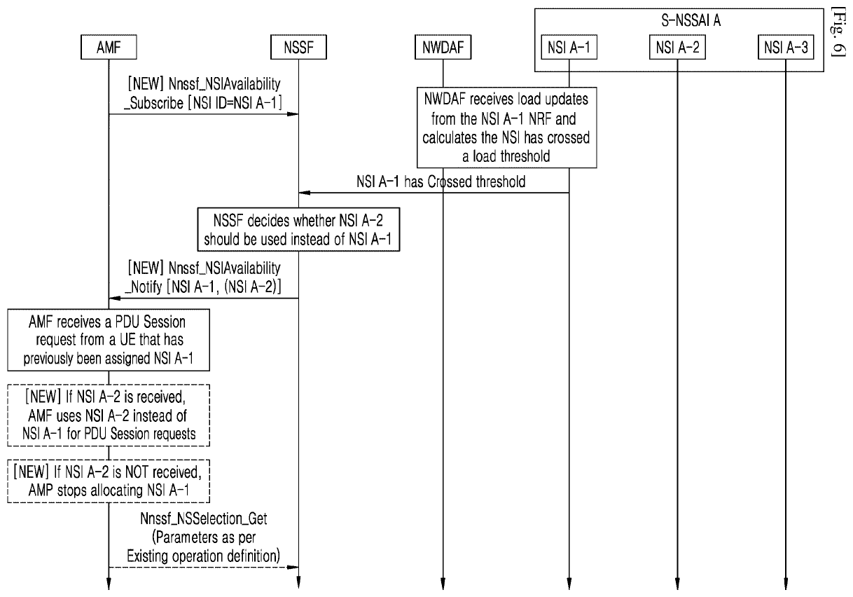

The skilled person will appreciate that the invention is not limited to the specific examples disclosed herein. For example, the techniques disclosed herein are not limited to 3GPP 5G. One or more entities in the examples disclosed herein may be replaced with one or more alternative entities performing equivalent or corresponding functions, processes or operations. One or more of the messages in the examples disclosed herein may be replaced with one or more alternative messages, signals or other type of information carriers that communicate equivalent or corresponding information. The skilled person will appreciate that one or more further elements or entities may be added to the examples disclosed herein. The skilled person will also appreciate that one or more non-essential elements or entities may be omitted in certain examples. For example, one or more of the operations surrounded by boxes with dotted outline and the message indicated with a dotted arrow illustrated in FIG. 6 may be omitted in certain examples. The functions, processes or operations of a particular entity in one example may be divided between two or more separate entities in an alternative example. The functions, processes or operations of two or more separate entities in one example may be performed by a single entity in an alternative example. Information carried by a particular message in one example may be carried by two or more separate messages in an alternative example. The information carried by two or more separate messages in one example may be carried by a single message in an alternative example. The order in which operations are performed and/or the order in which messages are transmitted may be modified, if possible, in alternative examples. The skilled person will appreciate that one or more criteria used in certain examples may be replaced by or supplemented with one or more other criteria in alternative examples. For example, a criteria that a load level has crossed a threshold in certain examples disclosed herein may be replaced by or supplemented with one or more other suitable criteria in alternative examples. The skilled person will also appreciate that a threshold or other value used in a criterion may be determined or set in any suitable way in various examples.

Certain examples of the disclosure provide a method, performed by a first entity, for Network Slice Instance (NSI) load distribution in a network comprising the first entity and a second entity providing slice-level network analytics, the method comprising: receiving a first message comprising information for determining that a first NSI should not be used, wherein the first NSI has been previously assigned to a User Equipment (UE); and upon receiving a session request from the UE, using an NSI different from the first NSI for the requested session.

The method may comprise transmitting a subscription request message for subscribing to information for determining that a first NSI should not be used.

In a first example: The first message may be received from a third entity that performs a network slice selection function. The first message may include information indicating that the first NSI should not be used. The first message may include an identification of a second NSI, and the step of using an NSI different from the first NSI for the requested session may comprises using the second NSI for the requested session. The method may comprise, if the first message does not include an identification of a second NSI, transmitting a request message to the third entity for requesting identification of a second NSI for the requested session. The method may comprise transmitting a subscription request message to the third entity for subscribing to information for network slice selection.

In a second example: The first message may be received from the second entity, the first message may include an indication that a load level associated with the first NSI satisfies a predetermined condition, and the method may comprise determining that the first NSI should not be used based on the indication. The predetermined condition is that the load level has exceeded a certain threshold. The method may comprise transmitting a subscription request message to the second entity for subscribing to load-level analytic information associated with the first NSI.

In a first alternative of the second example: The method may comprise transmitting a request message to a third entity that performs a network slice selection function for requesting identification of a second NSI for the requested session.

In a second alternative of the second example: The method may comprise determining a second NSI for the requested session using a predetermined network slice selection scheme.

Certain examples of the disclosure provide one or more of the following techniques.

Technique 1: If an NSI-ID has been allocated, a new service by the NSSF allows the AMF to be informed of NSI load status via the NSSF. The NSSF further determines whether the overloaded NSI can be replaced by one alternative NSI-ID to be used by all UEs whose PDU sessions had been allocated to such NSI. Depending on the NSI load notification received, the AMF either directly replaces the NSI-ID or queries the NSSF when a PDU session request arrives.

Technique 2a: The AMF directly subscribes to NWDAF slice load analytics. If an NSI overload notification is received, it stops allocating that NSI-ID to PDU session requests, and queries the NSSF for a new NSI-ID for each new PDU session request from UEs that had been using the overloaded NSI.

Technique 2b: This solution requires no NSSF involvement as the AMF subscribes directly to NWDAF and when an NSI overload notification is received it replaces on its own the old NSI-ID with new NSI-ID(s).

Technique 3 (and sub-techniques): A network operation relating to service experience (e.g. network load distribution and/or Operation and Maintenance (OAM) management), at slice and/or NSI level (e.g. network slice load distribution and/or network slice instance load distribution), may be triggered based on network analytics (e.g. slice service experience analytics and/or slice load analytics provided by NWDAF). The network operation may be triggered based on a decision made by NSSF and/or AMF, and/or any other suitable network entity. The network operation may include a restriction to one or more network slices and/or one or more network slice instances (e.g. during UE registration and/or PDU session establishment).

As well as coping with error cases (an NSI is overloaded, or malfunctioning) the system must be able to distribute load in a controllable way across NSIs that are “equivalent”, i.e. that could serve a UE where it is currently located (i.e. the service areas of the NSIs completely or partially overlap). This could be achieved using the solutions above, at the cost of additional network signaling if the NSI to be used for a UE needs to change frequently.

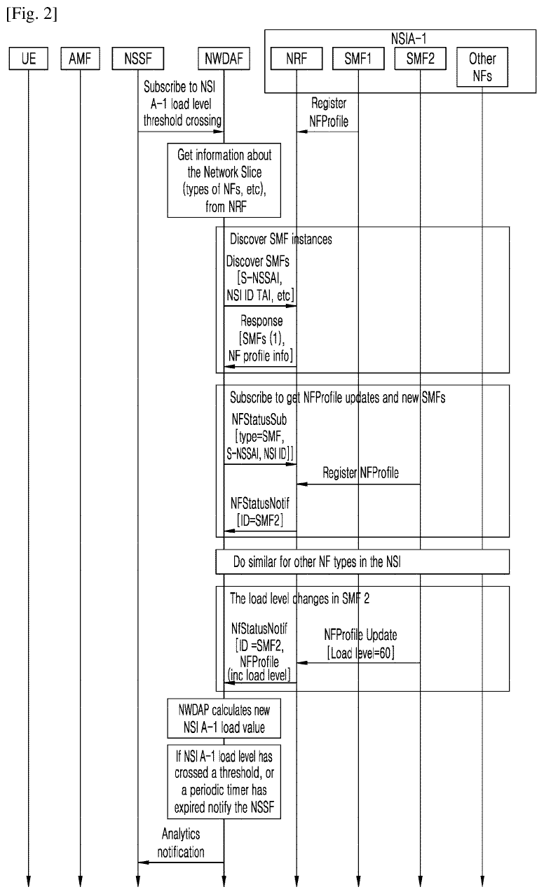

As noted above, the Rel-16 specifications already describe the possibility of the NSSF subscribing to information from the NWDAF about the load level of a Network Slice Instance (NSI). How the NWDAF obtains the load level of individual NF instances in an NSI is described, but how the NWDAF determines the NSI load level is not specified. Similarly, if needed the NSSF could also subscribe to slice QoE analytics (i.e., S-NSSAI level) with the purpose of determining correlations between slice load and slice SLA. FIG. 2 illustrates a first call flow: NSSF subscription to NSI load analytics according to an exemplary embodiment of the disclosure. With reference to FIG. 2, a first call flow shows an NSSF subscribing to notifications of load information about NSI A-1 and how this could trigger the NWDAF to start collecting that information. An NRF in the NSI is shown, along with two instances of SMFs, and there are other NFs of other types (e.g. could be Policy Control Function (PCF), User Plane Functions (UPFs), etc). In order to determine the NSI load the NWDAF first needs to know all of the NF instances that are currently part of the NSI so that it can subscribe to notifications from the NRF about the NFProfile updates from the NF instances that carry load information.

How the NWDAF finds all of the NF instances is not described explicitly in the specifications, but could be done in a number of ways:

Invoke Nnrf_NFDiscovery_Request for every possible NF type and see what comes back.

Invoke Nnrf_NFDiscovery_Request with a wild-card value for the NF Type. Wild-carding of the NF type does not seem to be supported in Release 16.

Obtain information about what NF types the NSI could contain, and invoke an Nnrf_NFDiscovery_Request for each type. This could be provisioned in a non-standardized way.

The first call flow shows the last option. Such an order of messages in this procedure has not been previously disclosed.

The composition of an NSI need not be static, so new NF instances could be created or deleted at any time. The first call flow shows the NWDAF invoking Nnrf_NFManagement_NFStatusSubscribe on the NRF for the SMF NF type. When a new NF of that type (in this example it is SMF 2) registers with the NRF the NRF notifies the NWDAF. The invocation of the Nnrf_NFManagement_NFStatusSubscribe operation also tells the NRF to inform the NWDAF of any NFProfile changes for any SMFs in the NSI. Subscriptions to NF Status changes would also be needed for all the other NF types that could be part of the NSI.

When the load level changes in SMF 2 it invokes Nnrf_NFManagement_NFUpdate on the NRF to inform it of the change, and the NRF in turn notifies the NWDAF.

The NWDAF then needs to determine whether this changes the load level of the NSI as a whole. As discussed already, the specifications do not describe what algorithm is used to translate NF instance load levels to overall NSI load level. The skilled person will appreciate that there are many possible algorithms.

If the NWDAF determines that the NSI load level has crossed a threshold, it informs the NSSF. The current specifications also indicate that the NSSF could be informed by the NWDAF of the NSI load level on a periodic basis. NWDAF could also provide statistics and/or predictions about both threshold crossings and load levels.

So, the first call flow shows a mechanism for providing NSI load information to the NSSF (or other entities). For multiple NSIs comprising the Network Slice/S-NSSAI as described previously the NSSF needs to decide which NSI should serve a UE, and NSI load information should be taken into account.

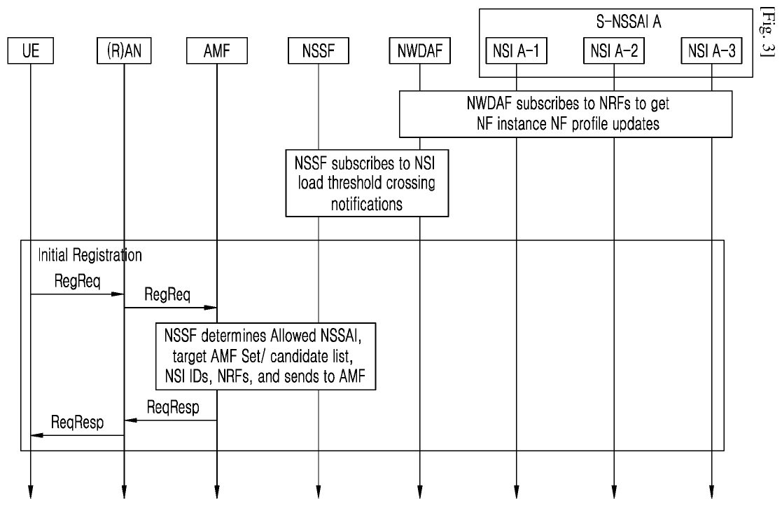

FIG. 3 illustrates a second call flow: Simplified registration procedure with NSI load analytics subscription according to an exemplary embodiment of the disclosure. With reference to FIG. 3, a second call flow shows the (simplified) steps involved in a UE's registration, following steps similar to the first call flow to set up NSI load monitoring at the NSSF for each of the NSI's.

When the UE registers it sends a list of requested S-NSSAI's that correspond to the slices it wants to use. If the network has deployed an NSSF the AMF asks it to determine the set of allowed S-NSSAI's by invoking the Nnssf_NSSelection_Get operation. As well as providing the Allowed NSSAI it can optionally provide NSI IDs and NRFs associated with the S-NSSAIs in the Allowed NSSAI. The NSSF can also provide AMF information in case re-selection of an AMF is needed. If there are multiple NSIs that could server the UE in its current Tracking Area (TA) the NSSF can select one of them “based on operator's configuration” (TS 23.501, clause 5.15.5, item B). The specification does not disclose what could be taken into consideration. NSI load level information is a possible candidate. The procedures in the first call flow show how the NSSF could obtain this information.

If there is only one NSI associated with the S-NSSAI then it is possible based on load level information that the NSSF could decide not to allow use of the S-NSSAI by the UE at that time. Modifications to the set of allowed S-NSSAIs may be possible. For operational reasons, such as NSI load level information, the network may change the set of allowed S-NSSAIs. This can be done either during a subsequent registration procedure, or using the User Configuration Update (UCU) procedure.

The NSSF is not a mandatory function, so in some networks the AMF would be responsible for all of the above, and so each AMF would need to subscribe to NSI load information notifications.

In conclusion, after completion of the registration procedure the UE knows which S-NSSAIs it is allowed to use, and the AMF also knows this information. The AMF might or might not know the NSI ID and NRF associated with each allowed S-NSSAI for that UE. The following discussions focus on one of the slices the UE is allowed to use, identified by S-NSSAI A.

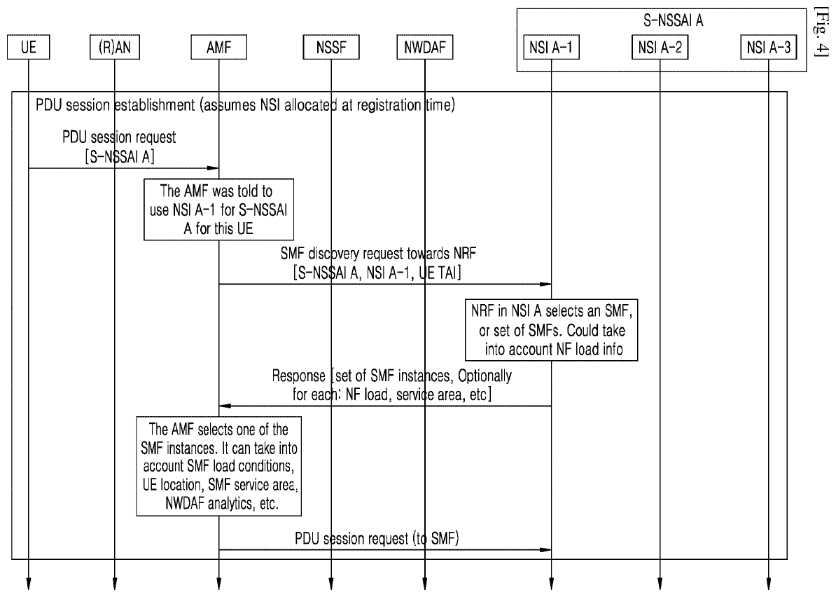

The next step for a UE is to try to establish a PDU Session to slice S-NSSAI A. FIG. 4 illustrates a third call flow: PDU session establishment with NSI-ID allocation according to an exemplary embodiment of the disclosure. With reference to FIG. 4, a third call flow shows the procedure if the NSSF (or AMF) decided on an NSI ID and NRF to be used for S-NSSAI A for this UE.

On receiving the establishment request the AMF interacts with the NRF that it has been given for the NSI in order to discover a set of candidate SMFs. The NRF can take into account load information that it receives from the SMF instances that are part of the NSI. The AMF then selects one of the SMFs, and can take into account information it has on the load being experienced by each, as well as other information. The selection functionality in the NRF and/or AMF can be seen as intra-NSI load balancing.

The NRF that the AMF interacts with can be specific to the NSI, or can serve multiple NSI's, even multiple NSIs of multiple slices. In these latter cases the AMF can include the S-NSSAI and/or NSI ID in the discovery request to ensure the NRF knows which NSI to select the SMFs from. If a single NRF does serve all the NSIs of a slice then as well as performing intra-NSI load balancing it could also perform inter-NSI load balancing. In this case an NSI ID would not be allocated by the NSSF or AMF.

Based on the existing specifications, in networks that deploy an NSSF the AMF will continue to use the same NSI ID and/or NRF until a re-registration is performed by the UE as there is no other trigger for it to interact with the NSSF.

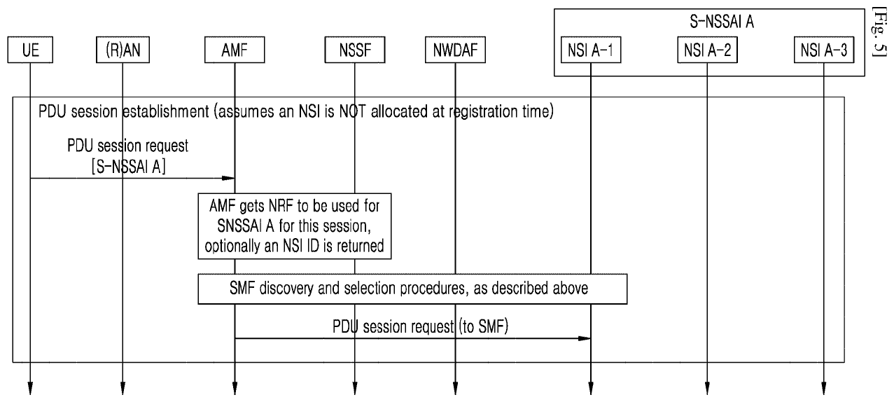

If an NSI ID and/or NRF were not allocated at registration time then the handling of a PDU Session establishment request from the UE is a little different. FIG. 5 illustrates a fourth call flow: PDU session establishment without NSI-ID allocation according to an exemplary embodiment of the disclosure. With reference to FIG. 5, a fourth call flow shows the steps if an NSSF is deployed. On receiving the request the AMF interacts with the NSSF using the Nnssf_NSSelection_Get operation. The AMF receives an NRF, and optionally receives an NSI ID.

SMF discovery and selection is then performed as described in the third call flow.

For subsequent PDU session establishment requests by this UE towards the same S-NSSAI there are two possibilities:

1. The AMF has previously received an NSI ID and NRF from the NSSF.

2. The AMF has previously received an NRF from the NSSF.

In case 1 it can be assumed that the AMF will continue to use the same NSI ID and NRF until it is triggered to interact with the NSSF again. Based on the current specifications this would be detrimental to load balancing across NSIs as it is not disclosed what would trigger that interaction. In case 2 the expected behaviour of the AMF is not disclosed in the specifications. It could continue to use the same NRF, or it could invoke Nnssf_NSSelection_Get for each PDU Session request. If the NRF serves all the NSIs of a slice then it is probably reasonable to use the same NRF each time, rather than interacting with the NSSF, as the NRF can perform both inter-and intra-NSI load balancing, but it is not disclosed how (except by configuration) the AMF would know that this NRF serves all the NSIs of a slice. However, if the NRF is specific to an NSI then as with case 1, the AMF will use the same NRF until it is triggered to interact with the NSSF again, and currently specified behaviour seems to be detrimental to load balancing across NSIs. Alternatively the AMF could invoke Nnssf_NSSelection_Get for each PDU Session request, but this may be relatively costly from a signaling load and performance point of view.

In the following is disclosed various techniques solving the issues described, i.e., that effective inter-NSI load balancing requires the network to use the most appropriate NSI for each PDU Session.

FIG. 6 illustrates a fifth call flow: first example (Example 1) for NSI load distribution according to an exemplary embodiment of the disclosure.

With reference to FIG. 6 illustrating a fifth call flow, in Example 1 the AMF subscribes to a (new) NSSF notification service to be informed if NSI A-1 is overloaded. As per existing specifications, the NWDAF receives load updates from the NRF serving NSI A-1, determines that the NSI has crossed a load threshold, and reports this to the NSSF (existing functionality). Upon being notified of the NSI A-1 overload, the AMF will react in one of two possible ways depending on the received NSSF overload notification, as described later in this report.

The new service to keep the AMF updated with NSI status per S-NSSAI is as follows.

Nnssf_NSIAvailability Service:

Service description: This service enables updating AMFs on the availability of NSIs on a per S-NSSAI basis.

### (2) Service Operation Name: Nnssf_NSIAvailability_Subscribe

Description: This service operation enables a NF Service Consumer (e.g. AMF) to subscribe to a notification of any changes in status of NSI availability information per S-NSSAI.

Inputs, Required: Callback URI (Uniform Resource Identifier) of the NF Service Consumer, list of S-NSSAIs.

Inputs, Optional: None.

Outputs, Required: Sub scriptionID.

Outputs, Optional: None.

Service operation name: Nnssf_NSIAvailability_Notify

Description: This service operation enables the NSSF to provide the NF Service Consumer (e.g. AMF) with changes in status of NSI availability information per S-NSSAI.

Inputs, Required: S-NSSAI, list of NSI IDs that have changed status, and status of each.

Inputs, Optional: Alternative NSI-ID where to offload new PDU sessions.

Outputs, Required: None.

Outputs, Optional: None.

Service operation name: Nnssf_NSIAvailability_Unsubscribe

Description: This service operation enables the NF Service Consumer (e.g. AMF) to unsubscribe to changes in status of NSI availability information per S-NSSAI.

Inputs, Required: Sub scriptionID.

Inputs, Optional: None.

Outputs, Required: None.

Outputs, Optional: None.

In the fifth call flow, the AMF invokes the new Nnssf_NSIAvailability_Subscribe operation on the NSSF, including the NSI ID that it wants to be kept informed about (in this example the NSI ID=A-1). When the NWDAF decides that an NSI A-1 load threshold has been crossed it informs the NSSF and the NSSF takes into account the load level it has for all of the NSIs of the slice and decides whether the AMF should use NSI A-2 instead of NSI A-1 for subsequent PDU Sessions. In the positive case, it notifies the AMF that from now on it should use NSI A-2 instead of NSI A-1. In the negative case, it only notifies the AMF of the status change of NSI A-1.

As previously mentioned, when the AMF is informed that the status of an NSI has changed, e.g. that a load level threshold has been crossed, it reacts in one of two possible ways, depending on whether the Nnssf_NSIAvailability_Notify operation includes the optional output parameter “alternative NSI ID”:

Alternative NSI ID provided in overload notification: The new NSSF overload notification service also allows the NSSF to provide an alternative NSI ID as an optional output parameter of the Nnssf_NSIAvailability_Notify operation to be used for subsequent PDU session establishment requests from UEs that were utilizing NSI A-1. This new NSI ID is only provided in case the NSSF estimates that all UEs previously using NSI A-1 are suitable for the new NSI ID. This notification informs the AMF that it should replace NSI A-1 with the new NSI ID. The notification includes the NSI ID and NRF of the NSI to be used in place of the existing information that the AMF has. The AMF uses this new NSI information for subsequent PDU Session establishment requests for those UEs that had been allocated the previous NSI.

No alternative NSI ID provided in overload notification: If the NSI overload notification to the AMF does not include a new NSI ID, the AMF stops allocating NSI A-1 and instead it interacts with the NSSF to get a new NSI ID and NRF. This interaction could be done via the regular Nnssf_NSSelection_Get operation with the same parameters as defined in the existing operation. What this means is that for subsequent PDU session requests by UE's that have been assigned the overloaded NSI ID it invokes Nnssf_NSSelection_Get using the parameters as defined in 23.502 (S-NSSAI, non-roaming/Local Break Out (LBO) roaming/Home Routed (HR) roaming indication, PLMN ID of the Subscription Permanent Identifier (SUPI), Tracking Area Identity (TAI), NF type of the NF service consumer, Requester ID). This is shown in the fifth call flow. Hence, the notification of the load level threshold crossing of the NSI is used by the AMF as an indication that in future it should query the NSSF for UE's that have previously been allocated that NSI.

Example 1 has the advantage of being adaptive, where the adaptation is decided by the NSSF after determining if all UEs that had been using the same NSI ID now overloaded can be safely offloaded to a new NSI ID: if such global offload is possible, the solution avoids the signaling that would ensue when the AMF needs to query the NSSF for a new NSI ID for each new PDU session request of UEs that had utilized the overload NSI ID. However, Example 1 also contemplates the case where a new NSI ID would not fit all UEs previously assigned to the overloaded NSI ID. Hence, if the NSSF determines that that such a global NSI offload is not viable, the AMF would invoke Nssf_NSSelection_Get for the subsequent PDU session requests. This example further assumes the AMF can decide that the right thing to do is to query the NSSF in response to being told about a load level threshold being crossed, but it isn't clear that this kind of decision belongs in the AMF.

This example assumes that all AMFs invoke Nnssf_NSIAvailability_Subscribe.

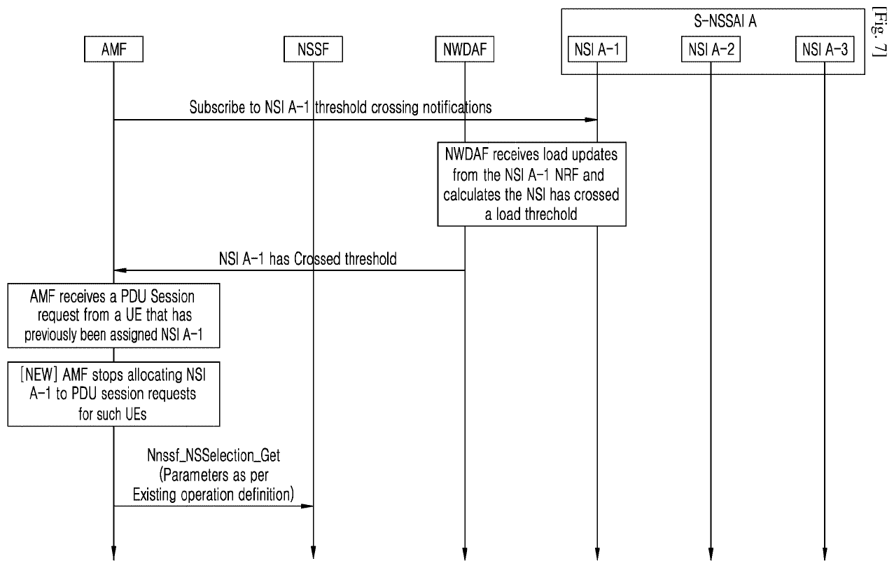

FIG. 7 illustrates a sixth call flow: second example (Example 2) for NSI load distribution according to an exemplary embodiment of the disclosure.

With reference to FIG. 7 illustrating a sixth call flow, in this example the NSSF is not involved, except to respond to the Nssf_NSSelection_Get invocations in the usual way. The AMF subscribes to load threshold crossing notifications for NSI A-1 directly from the NWDAF. When it receives such a notification it knows that for subsequent PDU session requests that would have used NSI A-1 it should invoke Nnssf_NSSelection_Get using the parameters as defined in 23.502 (S-NSSAI, non-roaming/LBO roaming/HR roaming indication, PLMN ID of the SUPI, TAI, NF type of the NF service consumer, Requester ID).

Example 2 ensures that there are no signalling storms when the NSI load level threshold is crossed, and fits more closely to existing procedures. However, it also means that the AMF invokes Nnssf_NSSelection_Get for the next PDU session establishment requests of all of the UE's that were given that NSI. This example assumes the AMF can decide that the right thing to do is to query the NSSF in response to being told about a load level threshold being crossed. In some examples this decision is performed by an entity other than AMF.

This example assumes that all AMFs subscribe to NSI threshold crossing notifications.

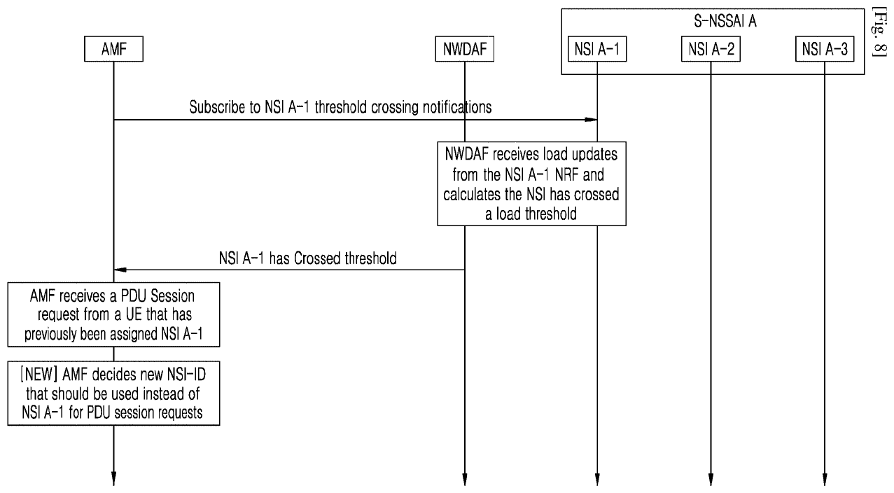

FIG. 8 illustrates a seventh call flow: third example (Example 3) for NSI load distribution according to an exemplary embodiment of the disclosure.

With reference to FIG. 8 illustrating a seventh call flow, Example 3 assumes that the NSSF is not needed at all to perform NWDAF-informed load distribution. Like Example 2, the AMF subscribes to NSI load notifications from NWDAF. The difference is that once a new PDU session request arrives from an UE for which the overloaded NSI was being used, the AMF decides by itself which new NSI-ID should be utilized for such PDU session without any interaction with the NSSF.

As NSSF is not a mandatory NF in the 5GC, Example 3 guarantees that NSI level load distribution can be performed also in the absence of NSSF. This means that part of the NSSF functionality is absorbed by another NF, in this case the AMF. In particular, the AMF needs to (i) subscribe to NWDAF slice load analytics, and (ii) be capable of deciding the new NSI to be used instead of the previously overloaded one for new PDU session requests coming from UEs allocated to the overloaded NSI. It is up to the AMF to decide whether the same new NSI-ID will be used for all PDU session requests, or the new NSI-ID can be chosen individually for each UE previously utilizing the overloaded NSI-ID.

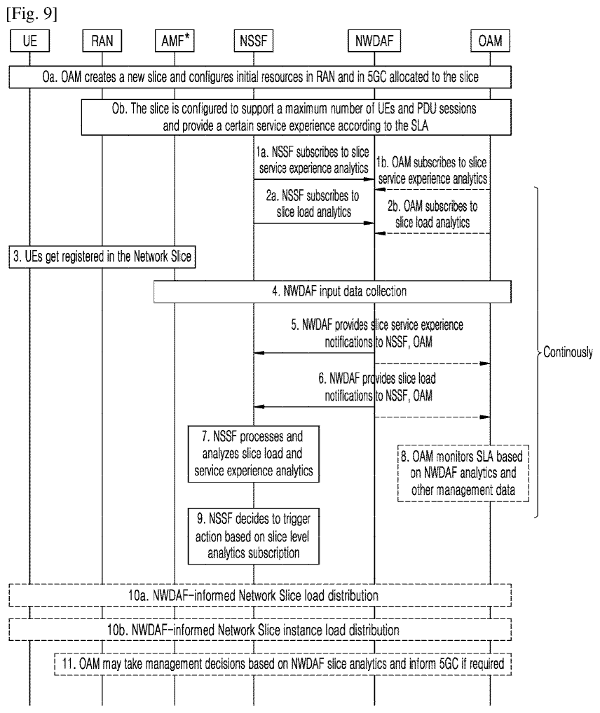

FIGS. 9-14 illustrates a fourth example (Example 4) for NSI load distribution according to an exemplary embodiment of the disclosure.

In this example, a network operation relating to service experience (e.g. network load distribution and/or OAM management), at slice and/or NSI level (e.g. network slice load distribution and/or network slice instance load distribution), may be triggered based on network analytics (e.g. slice service experience analytics and/or slice load analytics provided by NWDAF). The network operation may be triggered based on a decision made by NSSF, AMF, OAM, and/or any other suitable network entity. In certain examples, the network operation may include a restriction to one or more network slices and/or one or more network slice instances (e.g. during UE registration and/or PDU session establishment).

The skilled person will appreciate that the triggered network operations are not limited to the specific examples disclosed in FIGS. 9-14. Furthermore, any one network operation, or any suitable combination of two or more network operations, may be triggered. Network operation(s) may refer to one or more network operations disclosed in relation to FIGS. 9-14 and/or one or more other suitable network operations.

The skilled person will appreciate that a network operation may be triggered by any suitable network entity, not limited to AMF/AMF*, NSSF and OAM.

The skilled person will appreciate that the network analytics are not limited to the specific examples or combinations disclosed in FIGS. 9-14. Any suitable type of network analytics, and any suitable combination of different types of network analytics, may be used in various examples.

Various implementation are illustrated in FIGS. 9-14. However, the skilled person will appreciate that examples of the disclosure are not limited to the examples disclosed in relation to FIGS. 9-14.

In FIGS. 9-14, messages indicated with dashed arrows and operation indicated with dashed outline may be omitted in certain alternative example. The skilled person will appreciate that other of the messages and operations indicated (even those indicated with solid arrows and solid outline) may also be omitted in yet further alternative examples.

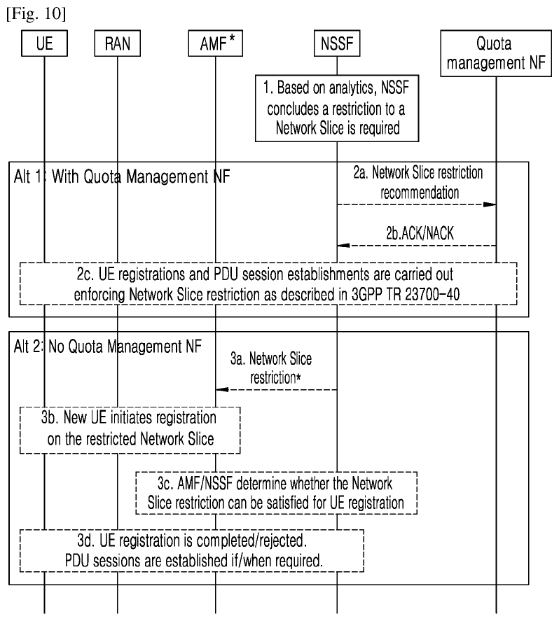

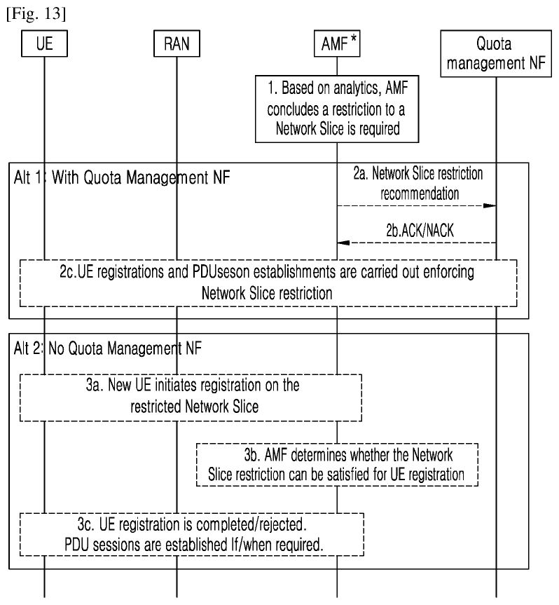

In FIGS. 9-14, “Alt” means “Alternative”. For example, in FIGS. 10 and 13, the set of messages/operations contained within box labelled “Alt 1” and the set of messages/operations contained within box labelled “Alt 2” may be regarded as alternatives illustrated in the same Figure for convenience and conciseness.

In the disclosure (including the description and Figures), where AMF* is indicated, it means the AMF instance involved in the call flow may refer to any AMF instance(s) within an AMF Set, for example defined as the AMF(s) that serve a given area and Network Slice(s). The skilled person will appreciate that, in certain alternative examples of the disclosure, AMF* in any of the examples disclosed herein may be substituted with AMF, and vice versa.

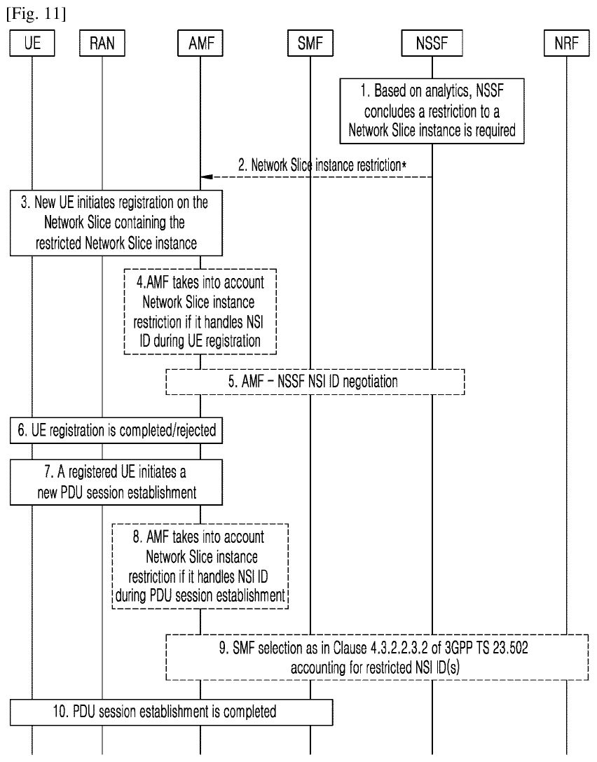

FIGS. 9-11 illustrate NSSF based solution: examples in which a network operation (e.g. network load distribution and/or OAM management) may be triggered based on a decision made by NSSF according to an exemplary embodiment of the disclosure. FIG. 9 illustrates an overall call flow while FIGS. 10 and 11 illustrate various examples of operations 10a and 10b of FIG. 9.

The various steps of FIG. 9, are described in the following.

0a.-0b. OAM creates a new slice and configures initial resources in RAN and in Core Network (CN) allocated to the slice. The slice may also be configured to support a maximum number of UEs and/or PDU sessions.

1a.-1b. NSSF and optionally OAM subscribe to slice service experience analytics from NWDAF. One or multiple subscriptions to one or multiple S-NSSAI(s), NSI ID(s) are possible.

2a.-2b. NSSF and optionally OAM subscribe to slice load analytics from NWDAF.

3. One or more new UEs get registered (e.g. continously) in the Network Slice.

4. NWDAF collects input data for deriving slice service experience analytics. For example, this may be performed as described in 3GPP TS 23.288 or according to any other suitable technique.

5. Slice service experience analytics are delivered (e.g. continuously) by NWDAF to NSSF and optionally to OAM.

6. Slice load analytics are delivered (e.g. continuously) by NWDAF to NSSF and optionally to OAM.

7. NSSF analyzes (e.g. continuously) statistics and/or predictions on slice load and service experience.

8. [OPTIONAL] OAM monitors (e.g. continuously) slice SLA. For that purpose, OAM may use, as optional inputs, NWDAF slice level analytics in addition to other management data.

9. NSSF decides to trigger action based on the slice analytics provided by NWDAF. Hence, NSSF may trigger either Network Slice load distribution or Network Slice instance load distribution, or both.

10a. [OPTIONAL] NSSF may trigger Network Slice load distribution.

10b. [OPTIONAL] NSSF may trigger Network Slice instance load distribution. In certain examples, Step 10b can only be applied if the deployment choice of the operator allows Network Slice instance(s) in the 5GC, and those are identified via NSI ID(s).

11. [OPTIONAL] OAM may take management decisions based on the collected inputs including management data and NWDAF analytics. If required, OAM may inform 5GC of such management decisions.

FIG. 10 illustrates non-limiting examples of Step 10a of FIG. 9: NWDAF-informed Network Slice load distribution. The various steps of FIG. 10 are described in the following.

1. Based on the slice level analytics provided by NWDAF, NSSF concludes a Network Slice restriction is required. FIG. 10 illustrates two possible alternatives to execute the restrictions, depending on whether there is a quota management NF in the network, for example enforcing a maximum quota of UE registrations and maximum quota of PDU sessions on a Network Slice.

Alternative 1: A quota management (QM) NF is present in the network. The QM NF may be a separate NF or may be incorporated into one or more other network NF entities (e.g. a NF other than NSSF).

2a. NSSF sends a message indicating (e.g. a recommendation for) a Network Slice restriction to the QM NF.

2b. [OPTIONAL] The QM NF may inform NSSF of having accepted or declined the recommendation for the Network Slice restriction.

*2092c. The enforcement of the Network Slice restriction may be performed by the QM NF according to 3GPP TR 23.700-40 or according to any other suitable technique.

Alternative 2: QM NF is incorporated into NSSF, or is not present in the network.

3a. NSSF sends a Network Slice restriction to AMF.

3b. The UE initiates registration procedure requesting registration on the restricted Network Slice (via e.g. S-NSSAI).

3c. AMF/NSSF determine whether the Network Slice restriction can be satisfied for UE registration. For example, this may be done leveraging the Network Slice registration procedures defined in 3GPP TS 23.501 or any other suitable technique.

3d. The UE registration is completed or rejected. If completed, PDU sessions may be established for the registered UE if/when required.

FIG. 11 illustrates a non-limiting example of Step 10b of FIG. 9: NWDAF-informed Network Slice instance load distribution. The various steps of FIG. 11 are described in the following.

2. Based on the slice level analytics provided by NWDAF, NSSF concludes a Network Slice instance restriction is required.

3. [OPTIONAL] NSSF sends a Network Slice instance restriction to AMF.

4. A new UE initiates a registration procedure requesting registration on the Network Slice (e.g. identified via S-NSSAI) containing the restricted Network Slice instance (e.g. identified via NSI ID).

5. [OPTIONAL] If AMF handles NSI ID(s) information during UE registration, AMF may take into account the Network Slice instance restriction to assign NSI ID to the new UE registration.

6. [OPTIONAL] AMF and NSSF may interact, for example as described in 3GPP TS 23.501 or any other suitable technique, to determine the NSI ID to be used for the new UE registration.

7. UE registration is completed or rejected.

8. A UE already registered in the network may request a new PDU session establishment, for example according to 3GPP TS 23.502 or any other suitable technique.

9. [OPTIONAL] If AMF handles NSI ID(s) information during PDU session establishment, AMF may take into account the Network Slice instance restriction to assign NSI ID to the new PDU session establishment.

10. SMF selection is performed, for example according to 3GPP TS 23.502 or any other suitable technique, accounting for the restricted NSI ID(s).

11. PDU session establishment is completed.

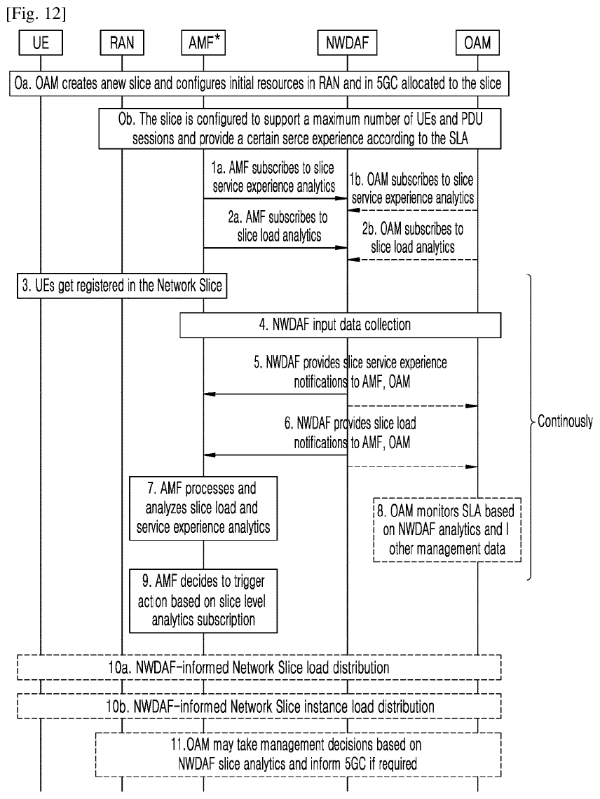

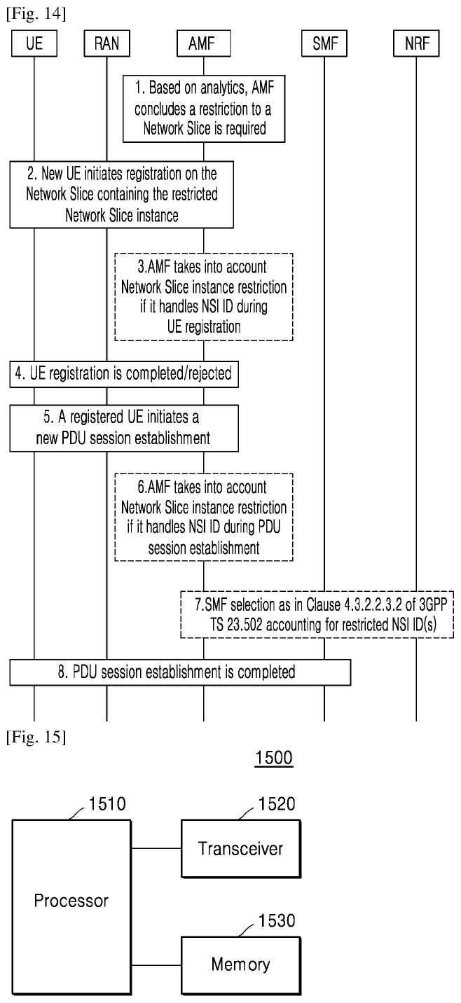

FIGS. 12-14 illustrate AMF based solution: examples in which a network operation (e.g. network load distribution and/or OAM management) may be triggered based on a decision made by AMF, according to an exemplary embodiment of the disclosure. FIG. 12 illustrates an overall call flow while FIGS. 13 and 14 illustrate various examples of operations 10a and 10b of FIG. 12.

The various steps of FIG. 12, are described in the following.

0a.-0b. OAM creates a new slice and configures initial resources in RAN and in CN allocated to the slice. The slice may also be configured to support a maximum number of UEs and/or PDU sessions.

1a.-1b. AMF and optionally OAM subscribe to slice service experience analytics from NWDAF. One or multiple subscriptions to one or multiple S-NSSAI(s), NSI ID(s) are possible.

2a.-2b. AMF and optionally OAM subscribe to slice load analytics from NWDAF.

3. One or more new UEs get registered (e.g. continously) in the Network Slice.

4. NWDAF collects input data for deriving slice service experience analytics. For example, this may be performed as described in 3GPP TS 23.288 or according to any other suitable technique.

5. Slice service experience analytics are delivered (e.g. continuously) by NWDAF to AMF and optionally to OAM.

6. Slice load analytics are delivered (e.g. continuously) by NWDAF to AMF and optionally to OAM.

7. AMF analyzes (e.g. continuously) statistics and/or predictions on slice load and service experience.

8. [OPTIONAL] OAM monitors (e.g. continuously) slice SLA. For that purpose, OAM may use, as optional inputs, NWDAF slice level analytics in addition to other management data.

9. AMF decides to trigger action based on the slice analytics provided by NWDAF. Hence, AMF may trigger either Network Slice load distribution, or Network Slice instance load distribution, or both.

10a. [OPTIONAL] AMF may trigger Network Slice load distribution.

10b. [OPTIONAL] AMF may trigger Network Slice instance load distribution. In certain examples, Step 10b can only be applied if the deployment choice of the operator allows Network Slice instance(s) in the 5GC, and those are identified via NSI ID(s).

11. [OPTIONAL] OAM may take management decisions based on the collected inputs including management data and NWDAF analytics. If required, OAM may inform 5GC of such management decisions.

FIG. 13 illustrates non-limiting examples of Step 10a of FIG. 12: NWDAF-informed Network Slice load distribution. The various steps of FIG. 13 are described in the following.

12. Based on the slice level analytics provided by NWDAF, AMF concludes a Network Slice restriction is required. FIG. 13 illustrates two possible alternatives to execute the restrictions, depending on whether there is a quota management NF in the network, for example enforcing a maximum quota of UE registrations and maximum quota of PDU sessions on a Network Slice.

Alternative 1: A quota management (QM) NF is present in the network. The QM NF may be a separate NF or may be incorporated into one or more other network NF entities (e.g. a NF other than AMF).

2a. AMF sends a message indicating (e.g. a recommendation for) a Network Slice restriction to the QM NF.

2b. [OPTIONAL] The QM NF may inform AMF of having accepted or declined the recommendation for the Network Slice restriction.

2c. The enforcement of the Network Slice restriction may be performed by the QM NF according to 3GPP TR 23.700-40 or according to any other suitable technique.

Alternative 2: QM NF is incorporated into AMF, or is not present in the network.

3a. The UE initiates registration procedure requesting registration on the restricted Network Slice (via e.g. S-NSSAI).

3b. AMF determines whether the Network Slice restriction can be satisfied for UE registration. For example, this may be done leveraging the Network Slice registration procedures defined in 3GPP TS 23.501 or any other suitable technique.

3c. The UE registration is completed or rejected. If completed, PDU sessions may be established for the registered UE if/when required.

FIG. 14 illustrates a non-limiting example of Step 10b of FIG. 12: NWDAF-informed Network Slice instance load distribution. The various steps of FIG. 14 are described in the following.

13. Based on the slice level analytics provided by NWDAF, AMF concludes a Network Slice instance restriction is required.

14. A new UE initiates a registration procedure requesting registration on the Network Slice (e.g. identified via S-NSSAI) containing the restricted Network Slice instance (e.g. identified via NSI ID).

15. [OPTIONAL] If AMF handles NSI ID(s) information during UE registration, AMF may take into account the Network Slice instance restriction to assign NSI ID to the new UE registration.

16. UE registration is completed or rejected

17. A UE already registered in the network may request a new PDU session establishment, for example according to 3GPP TS 23.502 or any other suitable technique.

18. [OPTIONAL] If AMF handles NSI ID(s) information during PDU session establishment, AMF may take into account the Network Slice instance restriction to assign NSI ID to the new PDU session establishment.

19. SMF selection is performed, for example according to 3GPP TS 23.502 or any other suitable technique, accounting for the restricted NSI ID(s).

20. PDU session establishment is completed.

Certain examples of the disclosure may be provided in the form of an apparatus/device/network entity configured to perform one or more defined network functions and/or a method therefor. Certain examples of the disclosure may be provided in the form of a system comprising one or more such apparatuses/devices/network entities, and/or a method therefor.

FIG. 15 is a block diagram of a network entity according to an exemplary embodiment of the disclosure.

The entity 1500 may correspond to base station (e.g., gNBs, eNBs or BSs) and a certain function (or component) in a core network. Also the entity 1500 may comprise at least one of the AMF, NSSF, OAM and NWDAF. Also, the entity 1500 may correspond to AMF, NSSF, OAM or NWDAF.

Furthermore, the entity 1500 illustrated in the FIG. 15 describes an embodiment of the physical component of entity 1500. The skilled person will appreciate that the network entity illustrated in FIG. 15 may be implemented, for example, as a network element on a dedicated hardware, as a software instance running on a dedicated hardware, or as a virtualised function instantiated on an appropriate platform, e.g. on a cloud infrastructure.

Referring to the FIG. 15, the entity 1500 comprises a processor (or controller) 1510, a transceiver 1520 and a memory 1530. However, all of the illustrated components are not essential. The entity 1500 may be implemented by more or less components than those illustrated in FIG. 15. In addition, the processor 1510 and the transceiver 1520 and the memory 1530 may be implemented as a single chip according to another embodiment.

The aforementioned components will now be described in detail.

The processor 1510 may include one or more processors or other processing devices that control the proposed function, process, and/or method. Operation of the entity 1500 may be implemented by the processor 1510.

According to various embodiments of the disclosure, the processor 1510 is configured for performing operations as described above in relation to FIGS. 1 to 14. For example, the processor 1510 is configured for performing the operations of an AMF, an NSSF, an OAM and/or an NWDAF.

The transceiver 1520 may include a RF transmitter for up-converting and amplifying a transmitted signal, and a RF receiver for down-converting a frequency of a received signal. However, according to another embodiment, the transceiver 1520 may be implemented by more or less components than those illustrated in components.

The transceiver 1520 may be connected to the processor 1510 and transmit and/or receive a signal. The signal may include control information and data. In addition, the transceiver 1520 may receive the signal through a wireless channel and output the signal to the processor 1510. The transceiver 1520 may transmit a signal output from the processor 1510 through the wireless channel.

According to various embodiments of the disclosure, the transceiver 1520 is configured for receiving one or more messages from one or more other network entities, for example one or more of the messages illustrated in FIGS. 1 to 14. the transceiver 1520 is configured for transmitting one or more messages to one or more other network entities, for example one or more of the messages illustrated in FIGS. 1 to 14.

The memory 1530 may store the control information or the data included in a signal obtained by the entity 1500. The memory 1530 may be connected to the processor 1510 and store at least one instruction or a protocol or a parameter for the proposed function, process, and/or method. The memory 1530 may include read-only memory (ROM) and/or random access memory (RAM) and/or hard disk and/or CD-ROM and/or DVD and/or other storage devices.

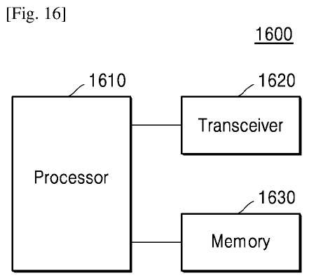

FIG. 16 illustrates a block diagram of a user equipment (UE), according to an exemplary embodiment of the disclosure.

The UEs described above may correspond to the UE 1600. For example, the UEs illustrated in FIGS. 2-5 and 9-14 may correspond to the UE 1600.

Referring to the FIG. 16, the UE 1600 may include a processor 1610, a transceiver 1620 and a memory 1630. However, all of the illustrated components are not essential. The UE 1600 may be implemented by more or less components than those illustrated in FIG. 16. In addition, the processor 1610 and the transceiver 1620 and the memory 1630 may be implemented as a single chip according to another embodiment.

The aforementioned components will now be described in detail.

The processor 1610 may include one or more processors or other processing devices that control the proposed function, process, and/or method. Operation of the UE 1600 may be implemented by the processor 1610.

The transceiver 1620 may include a RF transmitter for up-converting and amplifying a transmitted signal, and a RF receiver for down-converting a frequency of a received signal. However, according to another embodiment, the transceiver 1620 may be implemented by more or less components than those illustrated in components.

The transceiver 1620 may be connected to the processor 1610 and transmit and/or receive a signal. The signal may include control information and data. In addition, the transceiver 1620 may receive the signal through a wireless channel and output the signal to the processor 1610. The transceiver 1620 may transmit a signal output from the processor 1610 through the wireless channel.

The memory 1630 may store the control information or the data included in a signal obtained by the UE 1600. The memory 1630 may be connected to the processor 1610 and store at least one instruction or a protocol or a parameter for the proposed function, process, and/or method. The memory 1630 may include read-only memory (ROM) and/or random access memory (RAM) and/or hard disk and/or CD-ROM and/or DVD and/or other storage devices.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the disclosure. Accordingly, certain example provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

Although the disclosure has been described with an exemplary embodiment, various changes and modifications may be suggested to one skilled in the art. It is intended that the disclosure encompass such changes and modifications as fall within the scope of the appended claims.

According to various embodiments of the disclosure, a method, performed by a first network entity, for load distribution (e.g. network slice load distribution and/or network slice instance load distribution) in a network comprising the first entity and a second network entity providing network analytics is provided. The method comprise receiving, from the second entity, slice analytics; and determining, based on the slice analytics, to perform a network operation.

In an embodiment of the disclosure, the second entity may be an NWDAF entity.

In an embodiment of the disclosure, the slice analytics may comprise one or more of: network slice service experience analytics; network slice load analytics; network slice instance experience analytics; and network slice instance load analytics.

In an embodiment of the disclosure, the method may further comprise transmitting, to the second entity, a message (e.g. subscription request message) for requesting the slice analytics.

In an embodiment of the disclosure, determining to perform a network operation may comprise one or more of: monitoring a slice level agreement; and detecting a slice level agreement issue.

In an embodiment of the disclosure, the network operation may comprise one or more of: network slice load distribution; network slice instance load distribution; and an OAM network management operation.

In an embodiment of the disclosure, network slice load distribution may comprise restricting a network slice, and/or network slice instance load distribution may comprise restricting a network slice instance.

In an embodiment of the disclosure, the first network entity may be an NSSF entity, an AMF entity or an OAM entity.

In an embodiment of the disclosure, the network operation may comprise transmitting, to a quota management network entity, a network slice restriction recommendation, whereby UE registrations to the network and data session establishments (e.g. PDU session establishments) are carried out based on the network slice restriction.

In an embodiment of the disclosure, the network operation may comprise determining whether a network slice restriction can be satisfied for a UE registration to the network, whereby the UE registration may be completed or rejected based on the determining.

In an embodiment of the disclosure, the first entity may be an entity other than an AMF entity, the method may further comprise transmitting, to the AMF entity, the network slice restriction, and determining whether the network slice restriction can be satisfied may be performed by the first entity in cooperation with the AMF entity.

In an embodiment of the disclosure, performing the network operation may comprise one or more of: performing, by an AMF entity, a procedure for registering a UE to the network, taking into account a network slice instance restriction; and performing, by an AMF entity, a procedure for establishing a data session (e.g. a PDU session) for a UE registered to the network, taking into account a network slice instance restriction.

In an embodiment of the disclosure, the first entity may be an entity other that the AMF entity, and the method may further comprise transmitting, to the AMF entity, a network slice instance restriction.

According to various embodiments of the disclosure, a network entity (e.g. AMF entity, NSSF entity or OAM entity) is configured to operate according to a method of any of the above examples.

According to various embodiments of the disclosure, a network comprising one or more network entities according to the preceding example is provided.

According to various embodiments of the disclosure, a computer program comprising instructions which, when the program is executed by a computer or processor, cause the computer or processor to carry out a method according to any of the above examples is provided.

According to various embodiments of the disclosure, a computer or processor-readable data carrier having stored thereon a computer program according to the preceding example is provided.

According to various embodiments of the disclosure, a method, performed by a first entity, for Network Slice Instance (NSI) load distribution in a network comprising the first entity and a second entity providing slice-level network analytics is provided. The method comprises receiving a first message comprising information for determining that a first NSI should not be used, wherein the first NSI has been previously assigned to a User Equipment (UE); and upon receiving a session request from the UE, using an NSI different from the first NSI for the requested session.

In an embodiment of the disclosure, the method may further comprise transmitting a subscription request message for subscribing to information for determining that a first NSI should not be used.

In an embodiment of the disclosure, the first message may be received from a third entity that performs a network slice selection function.

In an embodiment of the disclosure, the first message may include information indicating that the first NSI should not be used.

In an embodiment of the disclosure, the first message may include an identification of a second NSI, and the step of using an NSI different from the first NSI for the requested session may comprise using the second NSI for the requested session.

In an embodiment of the disclosure, the method may further comprise, if the first message does not include an identification of a second NSI, transmitting a request message to the third entity for requesting identification of a second NSI for the requested session.

In an embodiment of the disclosure, the method may further comprise transmitting a subscription request message to the third entity for subscribing to information for network slice selection.

In an embodiment of the disclosure, the first message may be received from the second entity, and the first message may include an indication that a load level associated with the first NSI satisfies a predetermined condition. The method may further comprise determining that the first NSI should not be used based on the indication.

In an embodiment of the disclosure, the predetermined condition may be that the load level has exceeded a certain threshold.

In an embodiment of the disclosure, the method may further comprise transmitting a request message to a third entity that performs a network slice selection function for requesting identification of a second NSI for the requested session.

In an embodiment of the disclosure, the method may further comprise determining a second NSI for the requested session using a predetermined network slice selection scheme.

In an embodiment of the disclosure, the method may further comprise transmitting a subscription request message to the second entity for subscribing to load-level analytic information associated with the first NSI.

According to various embodiments of the disclosure, a method for Network Slice Instance (NSI) load distribution in a network comprising a first entity and a second entity providing slice-level network analytics is provided. The method comprises transmitting, by the second entity, load-level analytic information associated with a first NSI, wherein the first NSI has been previously assigned to a User Equipment (UE); receiving, by the first entity, a first message comprising information for determining that the first NSI should not be used; and upon receiving a session request from the UE, using, by the first entity, an NSI different from the first NSI for the requested session.

In an embodiment of the disclosure, the network may further comprise a third entity that performs a network slice selection function, and the load-level analytic information may be transmitted by the second entity to the third entity. The method may further comprise: determining, by the third entity, based on the load-level analytic information, whether the first NSI should not be used; if it is determined that the first NSI should not be used, transmitting, by the third entity to the first entity, the first message, wherein the first message includes information indicating that the first NSI should not be used.

In an embodiment of the disclosure, the first message may be transmitted by the second entity to the first entity and includes the load-level analytic information transmitted by the second entity, and the method may further comprise determining, by the first entity, based on the load-level analytic information, whether the first NSI should not be used.

In an embodiment of the disclosure, the method may further comprise receiving, by the second entity, load updates from the first NSI.

In an embodiment of the disclosure, the network may be a third generation partnership project (3GPP) fifth generation (5G) network; the first entity may be an Access and Mobility Management Function (AMF) entity; the second entity may be a Network Data Analytics Function (NWDAF) entity; the third entity may be a Network Slice Selection Function (NSSF) entity; and the session request may be a Protocol Data Unit (PDU) session request.

According to various embodiments of the disclosure, an apparatus of a first entity for Network Slice Instance (NSI) load distribution in a network comprising the first entity and a second entity providing slice-level network analytics is provided. The apparatus comprises a transceiver for receiving a first message comprising information for determining that a first NSI should not be used, wherein the first NSI has been previously assigned to a User Equipment (UE); and a processor for, upon receiving a session request from the UE, using an NSI different from the first NSI for the requested session.

According to various embodiments of the disclosure, a network comprising a first entity, a second entity and a third entity, and the network may be configured to perform the method according to any of the above examples is provided.

According to various embodiments of the disclosure, a computer program comprising instructions which, when the program is executed by a computer, cause the computer to carry out a method according to any of the above examples is provided.

According to various embodiments of the disclosure, a computer-readable data carrier having stored thereon a computer program according to the preceding example is provided.

1.-15. (canceled)

16. A method, performed by a first network entity, for performing network operation in a network comprising the first network entity and a second network entity providing network analytics, the method comprising:
subscribing to slice analytics from the second network entity;
receiving, from the second network entity, the slice analytics; and
determining, based on the slice analytics, to perform network operation.

17. A method according to claim 16, wherein the first network entity is an NSSF entity or an AMF entity.

18. A method according to claim 16, wherein the second network entity is an NWDAF entity.

19. A method according to claim 16, wherein the slice analytics comprise one or more of:
network slice service experience analytics; and
network slice load analytics.

20. A method according to claim 16, wherein the network operation comprise one or more of:
restriction to a network slice or a network slice instances;
network slice load distribution; and
network slice instance load distribution.

21. A method according to claim 16,
wherein the determining to perform network operation comprises:
determining, based on the slice analytics, to restrict a network slice;
identifying that a UE registration is requested on the restricted network slice;
determining whether the restriction of the network slice is satisfied for the UE registration;
allowing or rejecting the UE registration based on the determination result.

22. A method according to claim 21,
wherein the first entity is an NSSF entity,
wherein the determining to restrict the network slice comprises transmitting a message, to an AMF entity, indicating that the network slice is restricted, and
wherein the determining whether the restriction of the network slice is satisfied for the UE registration is performed in cooperation with the AMF entity.

23. A method according to claim 16,
wherein the determining to perform network operation comprises:
determining, based on the slice analytics, to restrict a network slice instance;
identifying that a UE registration is requested on a network slice containing the restricted network slice instance;
determining a network slice instance to be used for the UE registration taking into account the restricted network slice instance; and
performing a procedures for the UE registration by using the determined network slice instance.

24. A method according to claim 23,
wherein the first entity is an NSSF entity,
wherein the determining to restrict the network slice instance comprises transmitting a message, to an AMF entity, indicating that the network slice instance is restricted, and
wherein the determining the network slice instance to be used for the UE registration is performed in cooperation with the AMF entity.

25. A method according to claim 23, further comprising:
identifying that a PDU session establishment for a UE registered on the network is requested; and
performing a procedure for the PDU session establishment taking into account the restricted network slice instance.

26. A network entity configured to operate according to a method of claim 16

27. A network comprising one or more network entities according to claim 26.
